(19) United States
(12) Patent Application Publication
(10) Pub. No.: US 2025/0006413 A1
(43) Pub. Date: Jan. 2, 2025

(54) MAGNETIC BODY AND MAGNETIC ELEMENT

(71) Applicant: TOKIN CORPORATION, Shiroishi-shi, Miyagi (JP)

(72) Inventors: Satoru MATSUZAWA, Shiroishi-shi, Miyagi (JP); Akiko OSHIMA, Shiroishi-shi, Miyagi (JP); Chieko FUJIMOTO, Shiroishi-shi, Miyagi (JP); Yu KANAMORI, Shiroishi-shi, Miyagi (JP); Kaori OHDAIRA, Shiroishi-shi, Miyagi (JP)

(21) Appl. No.: 18/848,780

(22) PCT Filed: Mar. 7, 2023
(86) PCT No.: PCT/JP2023/008472

§ 371 Date: Sep. 19, 2024

(30) Foreign Application Priority Data
Mar. 24, 2022 (JP) 2022-048117

(51) Int. Cl. H01F 1/24; B22F 1/05; B22F 1/102; B22F 1/16; B22F 3/00; B22F 3/02; B22F 3/24; B22F 5/10; B22F 9/04; C22C 38/34

(52) U.S. Cl. CPC H01F 1/24; B22F 1/05; B22F 1/102; B22F 1/16; B22F 3/004; B22F 3/02; B22F 3/24; B22F 5/106; B22F 9/04; C22C 38/34; B22F 2003/248; B22F 2301/35; B22F 2302/45; B22F 2304/10; B22F 2998/10; B22F 2999/00; C22C 2202/02

(57) ABSTRACT

To provide a magnetic body and a magnetic element having excellent long-term heat resistance in a high-temperature environment of 180° C. The magnetic body according to one aspect of the present invention includes a soft magnetic powder and a resin cured product, and is a magnetic body having excellent long-term heat resistance in a high-temperature environment of 180° C.

### TECHNICAL FIELD

The present invention relates to a magnetic body and a magnetic element.

### BACKGROUND ART

In recent years, the demand for in-vehicle electronic components is increasing with the electrification of automobiles. In addition, in order to secure the space inside the vehicle, electronic components are arranged near the engine and motor, and there is a demand for further improvement in heat resistance. Magnetic elements used in electronic components are also required to have higher heat resistance. In addition, long-term heat resistance in a high temperature environment of 180° C. and maintenance of strength of the element against long-term vibration are required in order to ensure the function of the inductor for a long period of time.

A so-called plastic magnet is one example of a magnetic body used for a magnetic element. The plastic magnet is a magnet formed by molding a binder resin in which soft magnetic metal powder is dispersed into a predetermined shape by injection molding or the like. The plastic magnet relatively easily provides a magnetic body having a desired shape.

As one method for improving the heat resistance of a magnetic body, selection of a binder resin with excellent heat resistance has been investigated. For example, Patent Literature 1 discloses a magnetic core using a composite fluororesin containing a perfluoro fluororesin having excellent heat resistance.

In addition, it has been investigated to produce an integrated magnetic element in which a coil is embedded in a magnetic body by using a plastic magnet. For example, Patent Literature 2 discloses a method for producing an inductor in which a coil is arranged in a cavity and then the cavity is filled with a composition containing a thermoplastic element and magnetic powder. An integrally molded inductor also has the advantage of being able to suppress leakage magnetic flux without shielding.

### CITATION LIST

### Patent Literature

Patent Literature 1: Japanese Unexamined Patent Application Publication No. 2017-188680
Patent Literature 2: Japanese Unexamined Patent Application Publication No. 2019-102713

### SUMMARY OF INVENTION

### Technical Problem

An object of the present invention is to provide a magnetic body and a magnetic element having excellent long-term heat resistance in a high temperature environment of 180° C.

### Solution to Problem

The magnetic body according to the present invention includes a soft magnetic powder and a resin cured product, and has a radial crushing strength of 30 MPa or more after being held in an environment of 180° C. for 1000 hours.

One embodiment of the magnetic body has a strength retention rate of 50% or more after being held in an environment of 180° C. for 1000 hours.

One embodiment of the magnetic body has a volume resistivity of 10⁶ Ωcm or more after being held in an environment of 180° C. for 1000 hours.

One embodiment of the magnetic body has a radial crushing strength of 50 MPa or more after being held in an environment of 180° C. for 1000 hours.

One embodiment of the magnetic body has a weight change rate of 1% or less after being held in an environment of 180° C. for 1000 hours.

In one embodiment of the magnetic body, an average long diameter of voids in the resin cured product after being held in an environment of 180° C. for 1000 hours is 2 μm or less.

In one embodiment of the magnetic body, the average distance between the soft magnetic powder and the resin cured product is 1 μm or less after being held in an environment of 180° C. for 1000 hours.

In one embodiment of the magnetic body, the resin cured product has an imide bond.

In one embodiment of the magnetic body, the resin cured product includes polyesterimide.

In one embodiment of the magnetic body, the proportion of the resin cured product is 2 to 6 parts by mass relative to 100 parts by mass of the soft magnetic powder.

In one embodiment of the magnetic body, the resin cured product includes a cured product of a thermosetting resin composition containing a polyester-based resin, an epoxy-based resin, and a polyimide-based resin.

In one embodiment of the magnetic body, the polyester-based resin has a carboxy group.

In one embodiment of the magnetic body, the polyimide-based resin has an ethylenic double bond.

In one embodiment of the magnetic body, the thermosetting resin composition further contains a peroxide.

In one embodiment of the magnetic body, the soft magnetic powder contains an iron alloy powder.

In one embodiment of the magnetic body, the iron alloy powder contains an Fe—Si alloy.

In one embodiment of the magnetic body, the Fe—Si alloy contains 4 to 10% by mass of Si.

In one embodiment of the magnetic body, the iron alloy powder further contains one or more selected from Cr and Al.

In one embodiment of the magnetic body, the soft magnetic powder has an inorganic insulating layer on the surface.

In one embodiment of the magnetic body, the inorganic insulating layer contains one or more selected from a phosphate salt and a silicate salt.

In one embodiment of the magnetic body, the proportion of the inorganic insulating layer is 0.1 to 3 parts by mass relative to 100 parts by mass of the soft magnetic powder.

In one embodiment of the magnetic body, an average thickness of the inorganic insulating layer is 10 to 100 nm.

In one embodiment of the magnetic body, an average particle size of the soft magnetic powder is 5 to 30 μm.

The magnetic element according to the present invention includes the magnetic body according to the present invention, and a coil embedded in the magnetic body.

### Advantageous Effects of Invention

The present invention provides a magnetic body and a magnetic element that have excellent long-term heat resistance in a high-temperature environment of 180° C.

### BRIEF DESCRIPTION OF DRAWINGS

FIG. 1 is a schematic cross-sectional view showing an example of a magnetic body.

FIG. 2 is a schematic transparent view of a magnetic element according to one embodiment of the present invention.

FIG. 3 is a schematic cross-sectional view showing the III-III cross section of FIG. 2.

FIG. 4 is a cross-sectional SEM image of the magnetic body of Example 5.

FIG. 5 is a cross-sectional SEM image of the magnetic body of Example 6.

FIG. 6 is a cross-sectional SEM image of the magnetic body of Example 7.

FIG. 7 is a cross-sectional SEM image of the magnetic body of Example 8.

### DESCRIPTION OF EMBODIMENTS

The present invention will be described below through the embodiments of the invention, but the invention according to the claims is not limited to the following embodiments.

For clarity of explanation, the following description and drawings have been simplified as appropriate. For the purposes of explanation, the scale of each component in the drawings may differ significantly.

In addition, unless otherwise specified, “to” indicating a numerical range includes the lower limit value and the upper limit value thereof.

In the present invention, the term “magnetic body immediately after production” includes a magnetic body that has been stored at room temperature for up to about 24 hours after production.

### [Magnetic Body]

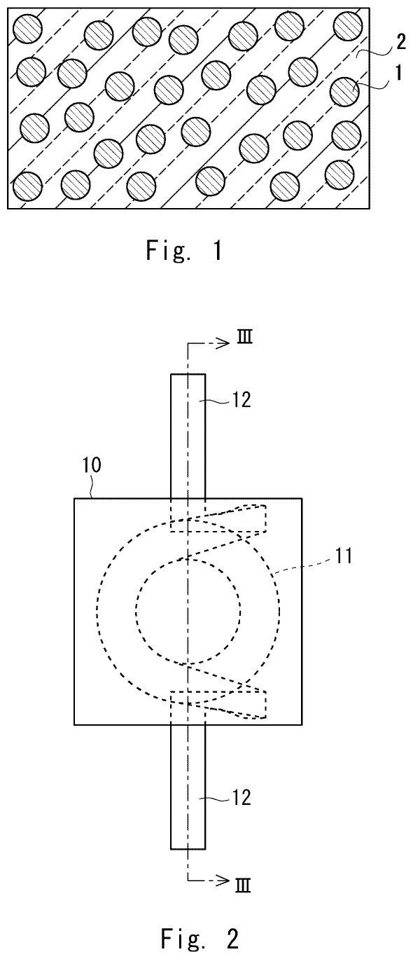

FIG. 1 is a schematic cross-sectional view showing an example of a magnetic body. A magnetic body 10 in the example of FIG. 1 (hereinafter also referred to as the present magnetic body) is a molded body having soft magnetic powder 1 and a resin cured product 2, with the soft magnetic powder 1 dispersed in the resin cured product 2.

The present magnetic body is characterized by a radial crushing strength of 30 MPa or more after being held in an environment of 180° C. for 1000 hours, and has excellent long-term heat resistance in a high-temperature environment of 180° C. In the present embodiment, the radial crushing strength is a value determined according to the JIS Z2507 radial crushing strength test method.

The radial crushing strength of the magnetic body after being held in an environment of 180° C. for 1000 hours is preferably 40 MPa or more, and more preferably 50 MPa or more.

The magnetic body preferably has a strength retention rate of 50% or more after being held in an environment of 180° C. for 1000 hours. The strength retention rate herein is a value calculated from the radial crushing strength K₀ (MPa) of the magnetic body immediately after production and the radial crushing strength K (MPa) of the magnetic body after being held in an environment of 180° C. for 1000 hours, using the following formula (1).

Strength retention rate (%)=K/K₀×100 Formula (1)

From the viewpoint of heat resistance, the strength retention rate is preferably 55% or more, and more preferably 60% or more. In addition, the radial crushing strength of the present magnetic body immediately after production is preferably 60 MPa or more, more preferably 70 MPa or more, and even more preferably 80 MPa or more.

It is preferable that the present magnetic body maintains insulating properties thereof even in a high-temperature environment. From such a viewpoint, it is preferable that the volume resistivity of the present magnetic body after being held in an environment of 180° C. for 1000 hours is 10⁶ Ωcm or more, and more preferably 10⁷ Ωcm or more.

In addition, the volume resistivity of the magnetic body immediately after production is preferably 10⁶ Ωcm or more, more preferably 10⁷ Ωcm or more, and even more preferably 10⁸ Ωcm or more.

From the viewpoint of maintaining strength, it is preferable that the weight change rate of the present magnetic body after being held in an environment of 180° C. for 1000 hours is 1% or less, more preferably 0.9% or less, and even more preferably 0.8% or less. Herein, the weight change rate is a value calculated from the weight W₀ (g) of the magnetic body immediately after production and the weight W (g) of the magnetic body after being held in an environment of 180° C. for 1000 hours, using the following formula (2).

Weight change rate (%)=|W−W₀|/W₀×100 Formula (2)

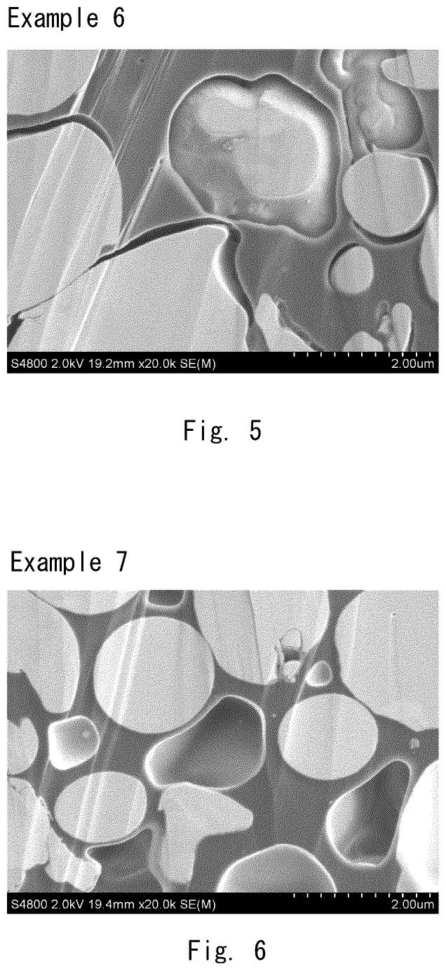

In addition, from the viewpoint of maintaining the strength of the magnetic body, it is preferable that decomposition of the resin cured product around the magnetic powder is suppressed in a high-temperature environment. FIG. 5 is a cross-sectional SEM image of the magnetic body of Example 6 described below. As shown in FIG. 5, decomposition of the resin cured product around the magnetic powder may progress in a high-temperature environment, and in this case, there is a tendency for the radial crushing strength to decrease significantly.

Specifically, from the viewpoint of maintaining strength, the magnetic body preferably has an average distance between the soft magnetic powder and the resin cured product of 1 μm or less, and more preferably 0.5 μm or less, after being held in an environment of 180° C. for 1,000 hours. The average distance herein is the average value of the width of the gap between the magnetic body and the resin in a cross-sectional SEM image of the magnetic body.

In addition, from the viewpoint of maintaining the strength of the magnetic body, it is preferable that the formation of large voids inside the resin cured product is suppressed in a high-temperature environment. Specifically, from the viewpoint of maintaining the strength of the magnetic body, it is preferable that the average long diameter of the voids in the resin cured product after being held in an environment of 180° C. for 1000 hours is 2 μm or less, and more preferably 1.5 μm or less. If the average long diameter is more than 2 μm, there is a tendency for the strength retention rate to decrease. Herein, the above average long diameter is the average value of the long diameters measured from each void in a cross-sectional SEM image of the magnetic body.

The present magnetic body may have at least a radial crushing strength of 30 MPa or more after being held in an environment of 180° C. for 1000 hours. There are no particular limitations on the method for achieving the long-term heat resistance described above, but it can be achieved, for example, by selecting the soft magnetic powder and resin cured product that constitutes the magnetic body.

Hereinafter, each component that can be contained in the present magnetic body will be explained.

### <Soft Magnetic Powder>

The soft magnetic powder can be appropriately selected from materials exhibiting soft magnetism. From the viewpoint of magnetic properties, it is preferable to use a powder containing iron, and it may be either iron singly or an alloy containing iron and other elements. The soft magnetic powder preferably contains an iron alloy powder such as carbonyl iron, Fe—Si alloy, Fe—Ni alloy, Fe—Si—Cr alloy, Fe—Si—Al alloy, Fe-based amorphous alloy powder containing at least Fe—B, and Fe-based nanocrystalline alloy containing at least Fe—B—P—Cu. Herein, the Fe-based amorphous alloy refers to an amorphous alloy that has no crystalline structure among Fe-based alloys. The Fe-based nanocrystalline alloy is an alloy in which fine α-Fe crystals are precipitated in the amorphous phase by subjecting the Fe-based amorphous alloy to heat treatment. The soft magnetic powder can be used singly or in combination of two or more types.

The iron alloy powder preferably contains an Fe—Si alloy, because the oxidation of iron in the soft magnetic powder in high-temperature environments is inhibited and also the catalytic action of iron at the contact surface between the iron and the resin cured product is inhibited, thereby inhibiting the thermal oxidative decomposition of the resin cured product. In addition, the use of an Fe—Si alloy can provide a magnetic body with high magnetic permeability and low core loss.

The proportion of Si in the Fe—Si alloy is preferably 4 to 10% by mass with respect to the total amount of the Fe—Si alloy. Further, from the viewpoint of the heat resistance of the magnetic body, the proportion of Si is preferably 4.5% by mass or more, and more preferably 5% by mass or more. On the other hand, from the viewpoint of suppressing the deterioration of the magnetic properties and suppressing the hardness and brittleness of the Fe—Si alloy, the proportion of Si is preferably 10% by mass or less, preferably 8% by mass or less, and still more preferably 7% by mass or less.

In addition, the Fe—Si alloy may further contain other elements such as Cr, Al, Mn, Ni, C, O, N, S, P, B, and Cu. From the viewpoint of heat resistance, the Fe—Si alloy powder preferably contains one or more selected from Cr and Al. Cr and Al form a passive layer on the surface of the Fe—Si alloy powder, thus suppressing the oxidation of the soft magnetic powder in a high temperature environment, and further suppressing contact between the resin cured product and iron to suppress the oxidation of the resin cured product.

The proportion of Cr or Al in the Fe—Si alloy is preferably 0.5 to 10 parts by mass, more preferably 3 to 8 parts by mass in 100 parts by mass of the Fe—Si alloy powder, from the viewpoint of heat resistance and rust prevention. When both Cr and Al are contained, the total mass is preferably within the above range.

The total content of elements other than Cr and Al is preferably 1 part by mass or less, preferably 0.5 parts by mass or less in 100 parts by mass of the soft magnetic powder, from the viewpoint of heat resistance and magnetic properties.

Examples of the shape of the soft magnetic powder include spherical, oval, needle, rod, and plate. The spherical shape is preferable from the viewpoint of filling the mold when molding the present magnetic body and reducing the contact area with the resin cured product and the like.

In addition, the average particle size of the soft magnetic powder is preferably 1 to 100 μm, more preferably 3 to 60 μm, from the viewpoint of heat resistance. Furthermore, from the viewpoint of the skin effect in use in a frequency band of 1 MHz or more, the average particle size is more preferably 5 to 30 μm.

The method for producing the soft magnetic powder is not particularly limited, and may be appropriately selected from known methods such as an atomizing method, a melt spinning method, a rotating electrode method, a mechanical alloying method, and a chemical deposition method by reduction. The atomizing method is preferable because spherical-shaped particles can be suitably obtained. Examples of the atomizing method include a gas atomizing method, a water atomizing method, a centrifugal force atomizing method, and a plasma atomizing method. The gas atomizing method or the water atomizing method is preferable from the viewpoint of mass production stability and productivity, and the water atomizing method is preferable from the viewpoint of easily obtaining a powder of 30 μm or less.

### (Inorganic Insulating Layer)

The soft magnetic powder may further have an inorganic insulating layer. Providing an inorganic insulating layer suppresses contact between the soft magnetic powders, ensuring insulation, and suppressing contact between the soft magnetic powder and the resin cured product, further suppressing thermal decomposition of the resin cured product. In addition, the use of an inorganic insulating layer further improves the heat resistance of the insulating layer itself.

Examples of an insulating material for the inorganic insulating layer include: an inorganic oxide such as SiO₂ (silicic acid), Al₂O₃ (alumina), and ZrO₂; a nitride such as Si₃N₄ and BN; a glass material such as silicate glass, borate glass, borosilicate glass, phosphate glass, and bismuth glass; and a mineral such as mica and clay. Of these, it is preferable to contain a phosphate salt and a silicate salt. The insulating material in the inorganic insulating layer can be used singly or in combination of two or more.

From the viewpoint of ensuring insulation resistance and suppressing oxidation of the resin cured product, the inorganic insulating layer accounts for preferably 0.1 parts by mass or more, more preferably 0.3 parts by mass or more, and still more preferably 0.5 parts by mass or more relative to 100 parts by mass of the soft magnetic powder. The inorganic insulating layer may account for 3 parts by mass or less relative to 100 parts by mass of the soft magnetic powder, preferably 2.5 parts by mass or less, more preferably 2.0 parts by mass or less from the viewpoint of magnetic properties.

The average thickness of the inorganic insulating layer is preferably 10 to 100 nm, more preferably 10 to 60 nm, from the viewpoint of ensuring insulation resistance and suppressing the oxidation of the resin cured product.

The thickness of the inorganic insulating layer can be determined by observing the soft magnetic powder surface with a transmission electron microscope (TEM). In addition, for simplicity, assuming that the soft magnetic powder is spherical particles with a single particle size, and using the specific surface area of the soft magnetic powder and the specific gravity of the insulating material, the average thickness of the inorganic insulating layer can be calculated from the following formulae (3) and (4).

Specific surface area of soft magnetic powder (m²/g)=6/[specific gravity of soft magnetic powder (g/m³)×particle size of soft magnetic powder (m)] Formula (3)

Inorganic insulating layer thickness (m)=mass of insulating material (g)/[mass of soft magnetic powder (g)×specific surface area of soft magnetic powder (m²/g)×specific gravity of coating powder (g/m³)] Formula (4)

The method of providing the inorganic insulating layer on the soft magnetic powder can be appropriately selected from, for example, a powder mixing method, an immersion method, a sol-gel method, a CVD method, a PVD method, or other known methods.

### <Resin Cured Product>

The present magnetic body includes a resin cured product. The resin cured product is a cured product of a resin used as a binder component. The resin may have curability due to a single component or a plurality of components, and examples thereof include a thermosetting resin and a photocurable resin. The curable resin in the present magnetic body is preferably a thermosetting resin from the viewpoint of achieving both processability during heat molding and heat resistance after production. In the present invention, the resin cured product refers to a product in which at least a part of a curable resin has undergone a crosslinking reaction. Examples of the resin cured product include epoxy resin cured products, polyimide, and polyamideimide.

In the present magnetic body, the resin cured product preferably has an imide bond (—C(═O)—NR—C(═O)— where R represents a hydrogen atom or an organic group) because of having excellent long-term heat resistance in high-temperature environments. In a resin cured product having an imide bond, the decomposition of the imide bond is suppressed even in high-temperature environments, voids are less likely to form, strength is less likely to decrease after long-term storage, and insulation properties are also maintained.

In order to further improve heat resistance, it is preferable that the resin cured product contains polyesterimide. In the present invention, polyesterimide refers to one having two or more ester bonds and two or more imide bonds in the molecule. The resin cured product having polyesterimide has a three-dimensional structure in which a plurality of polymer chains are crosslinked, and the resin cured product has a plurality of ester bonds and imide bonds, thereby stabilizing the structure, and further suppressing thermal decomposition in a high temperature environment of 180° C.

The thermosetting resin, which is the precursor of the resin cured product, is preferably one that forms a cured product containing a polyesterimide structure after curing. In particular, a thermosetting resin composition containing a polyester resin, an epoxy resin, and a polyimide resin is preferable because the present magnetic body can be easily molded at a low temperature. Using the thermosetting resin composition can set the heating temperature during molding to, for example, about 180° C.

The polyester resin can be appropriately selected and used from polymers of polycarboxylic acid and polyol. In particular, a polyester resin having a carboxyl group is preferable from the viewpoint of reactivity with the epoxy resin.

The polycarboxylic acid can be appropriately selected from compounds having two or more carboxylic acids in one molecule, and in particular, a dicarboxylic acid having two carboxylic acids in one molecule or an anhydride thereof is preferable.

Specific examples of the dicarboxylic acid include terephthalic acid, isophthalic acid, naphthalene dicarboxylic acid, succinic acid, adipic acid, and maleic acid, and these can be used singly or in combination of two or more. In the present invention, the polycarboxylic acid preferably contains one or more selected from isophthalic acid and maleic acid.

The polyol can be appropriately selected from a compound having two or more hydroxy groups in one molecule. Specific examples of the polyol include ethylene glycol, propylene glycol, 1,4-butanediol, 1,5-pentanediol, 1,6-hexanediol, 2-methyl-1,3-propanediol, 3-methyl-1,5-pentanediol, diethylene glycol, dipropylene glycol, neopentyl glycol, 1,3-butanediol, trimethylolpropane, glycerin, 1,4-cyclohexanediol, cyclohexanedimethanol, bisphenol A, and bisphenol F, and these can be used singly or in combination of two or more.

The polyester resin can be obtained by subjecting the above polycarboxylic acid and polyol to a dehydration condensation reaction by a known method. In addition, the commercially available product having a desired structure may be used.

The epoxy resin can be appropriately selected from a compound having one or more epoxy groups in one molecule. Suitable specific examples of the epoxy resin include an epibis epoxy resin obtained by condensation reaction of epichlorohydrin, bisphenol A, bisphenol F, and alkylene oxide-modified products thereof; a novolac-based epoxy resin obtained by condensation reaction of epichlorohydrin and a phenolic resin; and an alkyl glycidyl ether such as methyl glycidyl ether and butyl glycidyl ether, and these can be used singly or in combination of two or more.

The polyimide resin may be appropriately selected from a compound having two or more imide bonds in one molecule. In particular, those having an ethylenic double bond are preferable from the viewpoint of crosslinkability with other resins, and N,N′-(4,4′-diphenylmethane)diallylnadiimide and N,N′-(m-xylylene)diallylnadimide are preferable. The polyimide resin may be used singly or in combination of two or more.

From the viewpoint of the heat resistance and mechanical strength of the resin cured product obtained, the blending ratio of the thermosetting resin composition is preferably 20 to 50 parts by mass of the polyester resin, 1 to 25 parts by mass of the epoxy resin, and 1 to 15 parts by mass of the polyimide resin.

The thermosetting resin composition may further contain other components. Examples of the other component include a vinyl-based monomer, an epoxy acrylate, a curing agent, and a catalyst.

Examples of the vinyl-based monomer include a monomer having a vinyl group, (meth)acryloyl group, and the like, and examples thereof include: a vinyl-based monomer such as vinyl acetate and styrene; and an acrylic monomer such as methyl (meth)acrylate. The (meth)acryloyl group represents an acryloyl group or a methacryloyl group, and the same applies to (meth)acrylate.

Examples of the epoxy acrylate include a compound obtained by reacting epoxy groups of various epoxy resins with carboxyl groups of (meth)acrylic acid.

A peroxide is preferable as a curing agent for promoting the curing reaction of the thermosetting resin composition. Specific examples of the peroxide include dicumyl peroxide, 2,5-dimethyl-2,5-di(benzoylperoxy)hexane, 2,2-bis(tert-butyldioxy)octane, t-butylperoxatate, dicumyl peroxide, 2,5-dimethyl-2,5-di(t-butylperoxy)hexane, α,α′-bis(t-butylperoxy-m-isopropyl)benzene, t-butyl-cumyl-peroxide, di-t-butyl-peroxide, 2,5-dimethyl, and 2,5-di(t-butylperoxy)hexane-3.

In addition, imidazole, tertiary amines, and the like can be used as a reaction catalyst between a carboxyl group and an epoxy group.

When blending a vinyl-based monomer or epoxy acrylate in a thermosetting resin composition, the blending ratio is preferably such that the ratio between the total mass of the polyester resin, the epoxy resin, and the polyimide resin and the total mass of the vinyl-based monomer and the epoxy acrylate is 1:3 to 3:1.

The present magnetic body can be obtained, for example, by dispersing the soft magnetic powder in the thermosetting resin composition, filling a mold having a desired shape with the mixture, and heating the mixture. The heating conditions depend on the reactivity of the thermosetting resin composition, and for example, heating at 150 to 200° C. for about 0.5 to 12 hours allows the crosslinking reaction to proceed sufficiently.

In addition to an ester bond and an imide bond, a hydroxy group derived from the reaction between an epoxy group and a carboxy group is detected in the resin cured product obtained by curing the thermosetting resin composition.

The blending ratio of the thermosetting resin composition and the soft magnetic powder may be appropriately adjusted depending on the application and the like, and for example, is preferably 1 to 10 parts by mass, more preferably 2 to 6 parts by mass relative to 100 parts by mass of the soft magnetic powder. With the blending ratio equal to or more than the above lower limit value, the mechanical strength of the magnetic body is improved. With the blending ratio equal to or less than the above upper limit value, the magnetic properties are excellent.

The present magnetic body can be used for known applications in which magnetic bodies are used. This magnetic body has excellent long-term heat resistance in a high temperature environment of 180° C., and therefore can be suitably used as a core material for in-vehicle applications that require heat resistance in particular, particularly inductors placed near engines.

In addition, when the thermosetting resin composition is used, the heat treatment temperature during molding can be set to a relatively low temperature of about 180° C., and thus the use for coil-embedded magnetic element applications described later is preferably possible.

### [Magnetic Element]

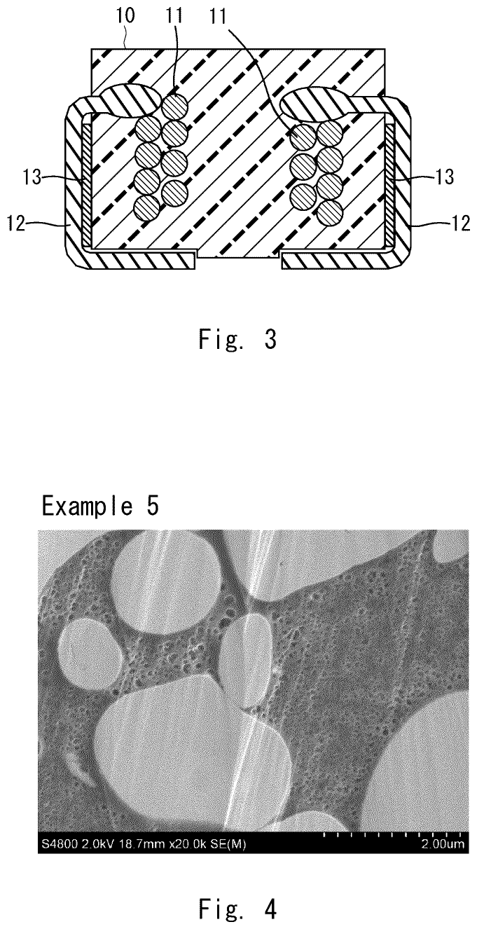

An example of the magnetic element (also referred to as the present magnetic element) according to the present invention will be described with reference to FIGS. 2 and 3. FIG. 2 is a schematic top transparent view of a magnetic element, and FIG. 3 is a schematic cross-sectional view taken along line III-III of FIG. 2. The terminal portion 12 in FIG. 2 is bonded to a magnetic body 10 using an adhesive member 13 in FIG. 3. The present magnetic element has the magnetic body 10 and a coil 11 embedded in the magnetic body 10, and the magnetic body 10 is the magnetic body according to the present invention. In the present magnetic element, at least the winding portion of the coil 11 is embedded in the magnetic body 10, and a part of the coil 11 may be exposed from the magnetic body 10. For example, a terminal portion 12 is made of copper plated with Sn or the like from the viewpoint of wettability of lead-free solder or the like. The copper of the terminal portion 12 may be joined with the coil 11 or may be integrated.

The shape of the coil 11 is appropriately selected from known coils used in magnetic elements, and typically, it has a winding portion and a terminal portion to be connected to a circuit or the like. The material of the coil 11 is not particularly limited, and may be, for example, a copper wire or the like, and the copper wire preferably has an insulating film. The insulating film is preferably a polyamideimide film, a polyimide film, or the like from the viewpoint of heat resistance.

When producing a coil-embedded magnetic element, the coil may be arranged in the mold before or during the filling of the mold with the magnetic body in the method for producing the magnetic body.

In addition, although not shown, a magnetic element produced by winding a coil around the present magnetic body also has excellent long-term heat resistance in a high temperature environment of 180° C.

The present magnetic element can be suitably used as an inductor used in power inductors, choke coils, transformers, and the like.

### EXAMPLES

Hereinafter, the present invention will be described in more detail with reference to Examples and Comparative Examples. In addition, these descriptions do not limit the present invention.

### Example 1

As the soft magnetic powder, there was prepared an Fe—Si—Cr alloy having an average particle size of 10 μm and containing 4.5 to 7% by mass of Si and 3 to 8% by mass of Cr.

The soft magnetic powder was coated with a phosphoric acid-based inorganic insulating material equivalent to 0.5 parts by mass relative to 100 parts by mass of the soft magnetic powder to form an insulating layer (the thickness of the insulating layer is about 10 nm). To the soft magnetic powder having the insulating layer, the following thermosetting resin composition (1) equivalent to 5 parts by mass relative to 100 parts by mass of the soft magnetic powder was added and kneaded to obtain an iron alloy powder coated with the thermosetting resin composition (1).

The thermosetting resin composition (1): a composition containing a polyester-based resin, an epoxy-based resin, and a polyimide-based resin.

The soft magnetic powder after the above treatment was passed through a metal mesh of 500 μm, and granulated by adjusting the particle size so as to be easily filled into a mold. The granulated powder was filled in a ring-shaped mold having an outer diameter of 13 mm and an inner diameter of 8 mm, and was pressure-molded at a molding pressure of 5 ton/cm². The resulting ring-shaped sample was thermoset at 180° C. for 2 hours or more in a constant temperature bath to obtain a magnetic body containing a resin cured product containing polyesterimide.

### Example 2

A magnetic body of Example 2 was obtained in the same manner as in Example 1, except that the amount of the phosphoric acid-based inorganic insulating material was changed to 1.5 parts by mass in Example 1 (the thickness of the insulating layer was about 50 nm).

### Example 3

The magnetic body of Example 3 was obtained in the same manner as in Example 1, except that the amount of the phosphoric acid-based inorganic insulating material in Example 1 was changed to 1.5 parts by mass, and the amount of the thermosetting resin composition (1) was changed to 2 parts by mass relative to 100 parts by mass of the soft magnetic powder.

### Example 4

A magnetic body of Example 4 was obtained in the same manner as in Example 1, except that the thermosetting resin composition in Example 1 was changed to a thermosetting phenolic resin.

### Example 5

A magnetic body of Example 5 was obtained in the same manner as in Example 1, except that the insulating coating treatment was not performed in Example 1.

### Example 6: Comparative Example

A magnetic body of Example 6 was obtained in the same manner as in Example 5, except that the thermosetting resin composition in Example 5 was changed to a thermosetting phenolic resin.

### Example 7

The magnetic body of Example 7 was obtained in the same manner as in Example 5, except that the thermosetting resin composition in Example 5 was changed to an epoxy resin having a glass transition temperature of 250° C. or more (epoxy resin (1)).

### Example 8

The magnetic body of Example 8 was obtained in the same manner as in Example 5, except that the thermosetting resin composition in Example 5 was changed to a bisphenol A type epoxy resin (epoxy resin (2)).

### Example 9

A magnetic body of Example 9 was obtained in the same manner as in Example 1, except that 0.5 parts by mass of the phosphoric acid-based inorganic insulating material was changed to 1 part by mass of the silicic acid-based insulating material, and the thermosetting resin composition was changed to a thermosetting phenolic resin in Example 1 (the thickness of the insulating layer was about 30 nm).

### Example 10

The magnetic body of Example 10 was obtained in the same manner as in Example 9, except that the soft magnetic powder in Example 9 was changed to a soft magnetic powder containing 6.5% by mass of Si, 3 to 8% by mass of Cr, and having an average particle size of 10 μm.

### Example 11

The magnetic body of Example 11 was obtained in the same manner as in Example 9, except that the soft magnetic powder in Example 9 was changed to a soft magnetic powder containing 0.5% by mass of Si, 1% by mass of Cr, and having an average particle size of 10 μm.

### <Evaluation of Magnetic Body>

The magnetic body of each example was evaluated by the following methods.

The volume resistivity of the magnetic body was calculated by measuring the insulation resistance using a Keysight resistance meter (B2985A) by applying a voltage of 100 V to the top and bottom surfaces of a ring-shaped molded body having an outer diameter of 13 mm, an inner diameter of 8 mm, and a height of 5.0 mm to 6.0 mm and placing electrodes with a diameter of 1 mm on the top and bottom surfaces.

The radial crushing strength of the magnetic body was calculated and evaluated by performing a compression test in accordance with the test method for radial crushing strength of JIS Z2507 from the formula (5).

K=[F×(D−e)]/(L×e²) Formula (5)
K: Radial crushing strength (MPa)
F: Maximum breaking load (N)
L: Length of hollow cylinder (mm)
D: Outer diameter of hollow cylinder (mm)
e: Wall thickness of hollow cylinder (mm)

### (Heat Resistance Evaluation)

Heat resistance was evaluated by storing each magnetic body in the atmosphere at 180° C., and after 1000 hours, measuring the volume resistivity, radial crushing strength, and weight in the same manner as above. The results are shown in Table 1. A − (negative) value for the weight change rate indicates a decrease in weight.

In addition, the cross section of the magnetic body after storage at 180° C. for 1000 hours was observed by SEM. Cross-sectional SEM images of the magnetic bodies of Examples 5 to 8 are shown in FIGS. 4 to 7.

### [Table 1]

TABLE 1

| | | Inorganic insulating layer | | | Resin cured product | | |
|---|---|---|---|---|---|---|---|
| | Soft | | Amount coated | | | Amount added | |
| | magnetic | | relative to 100 | | | relative to 100 | Weight |
| | powder | | parts by mass of | | | parts by mass of | change rate |
| | Proportion | | soft magnetic | | | soft magnetic | Ater storage |
| | of Si (% by | Insulating | powder (parts by | Thickness | | powder (parts by | at 180° C. for |
| Example | mass) | material | mass) | (nm) | Resin | mass) | 1000 hours |
| Example 1 | 4.5-7 | Phosphate- | 0.5 | [symbol] | Thermosetting | 5 | −0.37% |
| | | based | | | resin | | |
| | | insulating | | | composition (1) | | |
| | | material | | | | | |
| Example 2 | 4.5-7 | Phosphate- | 1.5 | [symbol] | Thermosetting | 5 | −0.40% |
| | | based | | | resin | | |
| | | insulating | | | composition (1) | | |
| | | material | | | | | |
| Example 3 | 4.5-7 | Phosphate- | 1.5 | [symbol] | Thermosetting | 2 | −0.19% |
| | | based | | | resin | | |
| | | insulating | | | composition (1) | | |
| | | material | | | | | |
| Example 4 | 4.5-7 | Phosphate- | 0.5 | [symbol] | Thermosetting | 5 | [symbol] |
| | | based | | | phenol resin | | |
| | | insulating | | | | | |
| | | material | | | | | |
| Example 5 | 4.5.7 | — | — | — | Thermosotting | 5 | −0.83% |
| | | | | | resin | | |
| | | | | | composition (1) | | |
| Example 6 | 4.5-7 | — | — | — | Thermosetting | 5 | −0.79% |
| | | | | | phenol resin | | |
| Example 7 | 4.5-7 | — | — | — | Epoxy resin (1) | 5 | −1.31% |
| Example 8 | 4.5-7 | — | — | — | Epoxy resin (2) | 5 | −1.73% |
| Example 9 | 4.5-7 | Silicic acid- | 1 | [symbol] | Thermosetting | | [symbol] |
| | | based | | | phenol resin | | |
| | | insulating | | | | | |
| | | material | | | | | |
| Example 10 | 0.5 | Silicic acid- | 1 | [symbol] | Thermosetting | 5 | −0.12% |
| | | based | | | phenol resin | | |
| | | insulating | | | | | |
| | | material | | | | | |
| Example 11 | 0.5 | Silicic acid- | 1 | [symbol] | Thermosetting | 5 | [symbol] |
| | | based | | | phenol resin | | |
| | | insulating | | | | | |
| | | material | | | | | |

| | | | Radial crushing | | | |
|---|---|---|---|---|---|---|
| | Volume resistivity (Ωcm) | | strength (MPa) | | | |
| | | After | | After | | |
| | Immediately | storage at | Immediately | storage at | Strength | |
| | after | 180° C. for | after | 180° C. for | retention | |
| Example | production | 1000 hours | production | 4000 hours | rate | |
| Example 1 | [symbol] × 10 [symbol] | [symbol] × 10 [symbol] | [symbol] | [symbol] | [symbol] | Example |
| Example 2 | [symbol] × 10 [symbol] | [symbol] × 10 [symbol] | [symbol] | [symbol] | [symbol] | Example |
| Example 3 | [symbol] × 10 [symbol] | [symbol] × 10 [symbol] | [symbol] | [symbol] | [symbol] | Example |
| Example 4 | [symbol] × 10 [symbol] | [symbol] × 10 [symbol] | [symbol] | [symbol] | [symbol] | Example |
| Example 5 | [symbol] × 10 [symbol] | [symbol] × 10 [symbol] | [symbol] | [symbol] | [symbol] | Example |
| Example 6 | [symbol] × 10 [symbol] | [symbol] × 10 [symbol] | [symbol] | [symbol] | [symbol] | Comparative |
| | | | | | | Example |
| Example 7 | [symbol] × 10 [symbol] | [symbol] × 10 [symbol] | [symbol] | [symbol] | [symbol] | Example |
| Example 8 | [symbol] × 10 [symbol] | [symbol] × 10 [symbol] | [symbol] | [symbol] | [symbol] | Example |
| Example 9 | [symbol] × 10 [symbol] | [symbol] × 10 [symbol] | [symbol] | [symbol] | [symbol] | Example |
| Example 10 | [symbol] × 10 [symbol] | [symbol] × 10 [symbol] | [symbol] | [symbol] | [symbol] | Example |
| Example 11 | [symbol] × 10 [symbol] | [symbol] × 10 [symbol] | [symbol] | [symbol] | [symbol] | Example |

[symbol]

indicates data missing or illegible when filed

FIG. 5 is a cross-sectional SEM image of Example 6. The magnetic body of Example 6, which combines soft magnetic powder without an inorganic insulating layer with thermosetting phenolic resin, was stored at 180° C. for 1000 hours, and it became clear that the resin around the soft magnetic powder had decomposed, resulting in gaps between the soft magnetic powder and the resin cured product. This resulted in a particularly low strength retention rate.

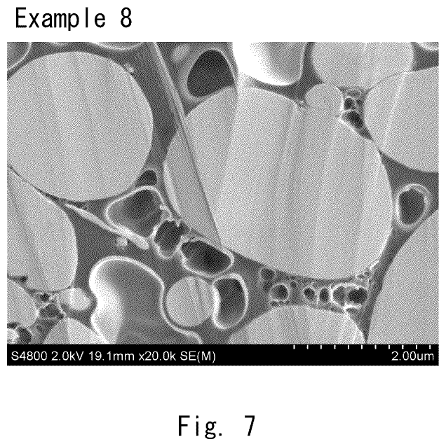

FIGS. 6 and 7 are cross-sectional SEM images of Examples 7 and 8. When the magnetic bodies of Examples 7 and 8 using epoxy resin were stored at 180° C. for 1000 hours, voids were generated inside the resin cured product. As a result, the strength retention rate was slightly reduced.

FIG. 4 is a cross-sectional SEM image of Example 5. When the magnetic body of Example 5 was stored at 180° C. for 1000 hours, voids were generated inside the resin cured product, but they did not expand, indicating that the mesh structure of polyesterimide was maintained. The magnetic body of Example 5 had a high strength retention rate after storage at 180° C. for 1000 hours, and also maintained the insulating properties thereof. Similar results were obtained for Examples 1 to 3. Further, Examples 1 to 3, which had an inorganic insulating layer, showed higher volume resistivity and radial crushing strength after storage at 180° C. for 1000 hours compared to Example 5, which did not have an inorganic insulating layer.

In addition, the magnetic bodies of Examples 9 and 10, in which the proportion of Si in the soft magnetic powder is within the range of 4 to 10% by mass, are superior in heat resistance compared to Example 11, which is outside the range, and the decrease in volume resistivity when stored at 180° C. for 1000 hours is suppressed. The radial crushing strength of Examples 9 and 10 after storage at 180° C. for 1000 hours is 30 MPa or more.

This application claims priority based on Japanese Patent Application No. 2022-48117 filed on Mar. 24, 2022, the disclosure of which is entirely incorporated herein.

### REFERENCE SIGNS LIST

1 SOFT MAGNETIC POWDER
2 RESIN CURED PRODUCT
10 MAGNETIC BODY
11 COIL
12 TERMINAL PORTION
13 ADHESIVE MEMBER

1. A magnetic body, comprising:
a soft magnetic powder; and
a resin cured product,
wherein the magnetic body has a radial crushing strength of 30 MPa or more after being held in an environment of 180° C. for 1000 hours.

2. The magnetic body according to claim 1, wherein the magnetic body has a strength retention rate of 50% or more after being held in an environment of 180° C. for 1000 hours.

3. The magnetic body according to claim 1, wherein the magnetic body has a volume resistivity of 10⁶ Ωcm or more after being held in an environment of 180° C. for 1000 hours.

4. The magnetic body according to claim 1, wherein the magnetic body has a radial crushing strength of 50 MPa or more after being held in an environment of 180° C. for 1000 hours.

5. The magnetic body according to claim 1, wherein the magnetic body has a weight change rate of 1% or less after being held in an environment of 180° C. for 1000 hours.

6. The magnetic body according to claim 1, wherein an average long diameter of voids in the resin cured product after being held in an environment of 180° C. for 1000 hours is 2 μm or less.

7. The magnetic body according to claim 1, wherein an average distance between the soft magnetic powder and the resin cured product is 1 μm or less after being held in an environment of 180° C. for 1000 hours.

8. The magnetic body according to claim 1, wherein the resin cured product has an imide bond.

9. The magnetic body according to claim 1, wherein the resin cured product includes polyesterimide.

10. The magnetic body according to claim 1, wherein a proportion of the resin cured product is 2 to 6 parts by mass relative to 100 parts by mass of the soft magnetic powder.

11. The magnetic body according to claim 1, wherein the resin cured product includes a cured product of a thermosetting resin composition containing a polyester-based resin, an epoxy-based resin, and a polyimide-based resin.

12. The magnetic body according to claim 11, wherein the polyester-based resin has a carboxy group.

13. The magnetic body according to claim 11, wherein the polyimide-based resin has an ethylenic double bond.

14. The magnetic body according to claim 11, wherein the thermosetting resin composition further contains a peroxide.

15. The magnetic body according to claim 1, wherein the soft magnetic powder includes an iron alloy powder, wherein the iron alloy powder includes an Fe—Si alloy containing 4 to 10% by mass of Si.

16. (canceled)

17. (canceled)

18. The magnetic body according to claim 15, wherein the iron alloy powder further includes one or more selected from Cr and Al.

19. The magnetic body according to claim 1, wherein the soft magnetic powder has an inorganic insulating layer on a surface thereof, wherein the inorganic insulating layer includes one or more selected from a phosphate salt and a silicate salt.

20. (canceled)

21. The magnetic body according to claim 19, wherein a proportion of the inorganic insulating layer is 0.1 to 3 parts by mass relative to 100 parts by mass of the soft magnetic powder.

22. The magnetic body according to claim 19, wherein an average thickness of the inorganic insulating layer is 10 to 100 nm.

23. The magnetic body according to claim 1, wherein an average particle size of the soft magnetic powder is 5 to 30 μm.

24. A magnetic element, comprising:
the magnetic body according to claim 1; and
a coil embedded in the magnetic body.
